(19) United States
(12) Patent Application Publication
(10) Pub. No.: US 2026/0228347 A1
(43) Pub. Date: Aug. 6, 2026

(54) INFORMATION PROCESSING APPARATUS AND INFORMATION PROCESSING METHOD

(71) Applicant: Toshiba Tec Kabushiki Kaisha, Tokyo (JP)

(72) Inventor: Yoshihiro KOMATSUBARA, Mishima Shizuoka (JP)

(21) Appl. No.: 19/442,431

(22) Filed: Jan. 7, 2026

(30) Foreign Application Priority Data
Feb. 3, 2025 (JP) 2025-016318

(51) Int. Cl. G06F 21/60; G06F 21/57

(52) U.S. Cl. CPC G06F 21/604; G06F 21/572; G06F 2221/2141

(57) ABSTRACT

In accordance with an embodiment, an information processing apparatus enters an update mode to prohibit the execution of the program and updates the program in response to a program update request from an authorized person authorized to install the program. The information processing apparatus generates an update program list constituted by a file path in the storage device of the program generated by the update. Further, the information processing apparatus rebuilds the white list on the basis of the update program list.

### CROSS-REFERENCE TO RELATED APPLICATIONS

This application is based upon and claims the benefit of priority from the prior Japanese Patent Application No. 2025-016318, filed on February 3, 2025, the entire contents of which are incorporated herein by reference.

### FIELD

An embodiment described here generally relates to an information processing apparatus and an information processing method.

### BACKGROUND

When an information processing apparatus attempts to execute a program running on the information processing apparatus, the information processing apparatus determines whether or not the execution of the program is permitted by using a white list. The white list is a list of pairs each being a pair of file path information and a hash value calculated from a program file related to each of programs installed in the information processing apparatus.

Various technologies have been proposed to detect non-legitimate rewriting and prevent program tampering in an information processing apparatus equipped with such a white list-type anti-malware for the purpose of preventing a reduction in operating rate while maintaining security. For example, a technique by which for updating a legitimate program, an authorized person authorized to install the program, such as an administrator or serviceman, updates the program, and then rebuilds a white list including files not updated, is proposed. However, rebuilding all such white lists is time-consuming.

### BRIEF DESCRIPTION OF THE DRAWINGS

FIG. 1 is a block diagram showing an example of a configuration of an image forming apparatus that serves as a information processing apparatus according to an embodiment.

FIG. 2 is a schematic diagram showing an example of the registration contents of a white list file stored in a white list file storage unit of the image forming apparatus.

FIG. 3 is a schematic diagram showing an example of a determination result as to whether or not the execution is permitted based on the white list at a program execution start time in the image forming apparatus.

FIG. 4 is a flowchart showing an example of a white list update processing operation executed by a processor of the image forming apparatus.

FIG. 5 is a flowchart showing an example of an update processing operation in FIG. 4.

FIG. 6 is a schematic diagram showing an example of a update program list generated in the update processing operation in FIG. 5.

FIG. 7 is a flowchart showing an example of an update processing operation in a white list update processing operation executed by a processor of an image forming apparatus according to a second embodiment.

FIG. 8 is a schematic diagram showing an example of update files expanded to a temporary directory in the update processing operation in FIG. 7.

### DETAILED DESCRIPTION

In accordance with an embodiment, when an information processing apparatus determines attempts to execute a program running on the information processing apparatus, the information processing apparatus determines whether or not the execution of the program is permitted. The information processing apparatus includes a storage device and a processor. The storage device saves a white list that is a list of an entity of an installed program and discriminative information for determining whether or not the execution of the program is permitted. The processor enters an update mode to prohibit the execution of the program and update the program in response to a program update request from an authorized person authorized to install the program and terminate the update mode in accordance with update end of the program. The processor generates, on the update mode, an update program list constituted by a file path in the storage device of the program generated by the update. Further, the processor rebuilds the white list on the basis of the update program list.

### First Embodiment

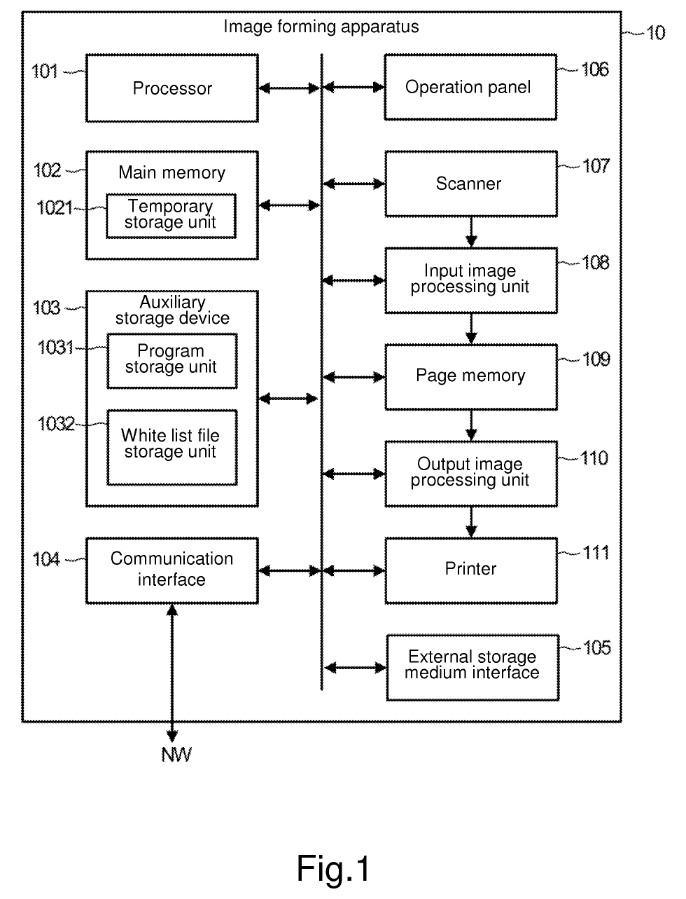

Hereinafter, embodiments will be described with reference to the drawings. In the drawings, the same reference signs denote identical or similar portions. FIG. 1 is a block diagram showing an example of a configuration of an image forming apparatus 10 that is an information processing apparatus according to the first embodiment. For example, the image forming apparatus 10 may be multi-function peripherals (hereinafter referred to as MFP) with at least a scan function and a print function. For example, the image forming apparatus 10 is connected to one or more user terminals (not shown) via a network, such as an in-house local area network (LAN). The user terminals are personal computers and the like. The user terminals are capable of sending print jobs to the image forming apparatus 10 for forming images or receiving and displaying document data scanned by the image forming apparatus 10.

As shown in FIG. 1, the image forming apparatus 10 includes a processor 101, a main memory 102, an auxiliary storage device 103, a communication interface 104, an external storage medium interface 105, an operation panel 106, a scanner 107, an input image processing unit 108, a page memory 109, an output image processing unit 110, and a printer 111, for example. These components are connected to one another via a data bus or the like. It should be noted that the image forming apparatus 10 may include configurations depending on needs in addition to the configurations as shown in FIG. 1 or certain configurations of the configurations as shown in FIG. 1 may be excluded.

For example, the processor 101 is a central processing unit (CPU), though not limited thereto. The processor 101 may be multi-core/multi-thread, and is capable of executing a plurality of processes in parallel. Moreover, the processor 101 is a micro processing unit (MPU). The processor 101 has a function of controlling general operations of the image forming apparatus 10. The processor 101 may include an internal memory, various interfaces, and the like. The processor 101 achieves various types of processing by executing a program prestored in the internal memory, the auxiliary storage device 103, or the like.

It should be noted that some of various functions achieved by the processor 101 executing programs may be achieved by hardware circuits including integrated circuits, such as an application specific integrated circuit (ASIC), a digital signal processor (DSP), a field-programmable gate array (FPGA), a graphics processing unit (GPU), a system on a chip (SoC), and a programmable logic device (PLD) in various forms. In this case, the processor 101 controls the functions executed by the hardware circuits.

The main memory 102 is a volatile memory. The main memory 102 is a working memory or a buffer memory. The main memory 102 is capable of storing various application programs on the basis of commands from the processor 101. Moreover, the main memory 102 can include a temporary storage unit 1021. The temporary storage unit 1021 stores data required to execute control programs and application programs stored in the auxiliary storage device 103, results of executing the programs, and the like.

The auxiliary storage device 103 is nonvolatile internal storage capable of writing and rewriting data. For example, a storage device, such as a hard disk drive (HDD), a solid state drive (SSD), or a flash memory, is employed as the auxiliary storage device 103. The auxiliary storage device 103 stores the control programs, the application programs, and various types of data, and the like depending on purposes of the operation of the image forming apparatus 10. For example, the auxiliary storage device 103 includes a program storage unit 1031 that stores application programs and a white list file storage unit 1032 that stores a white list file. The white list file will be described later. Moreover, the auxiliary storage device 103 is also capable of storing print jobs and the like sent from the user terminals. Each of the print jobs includes data to be printed, such as character data and image data, which is the source of the image to be formed on paper. The data to be printed may be data for forming an image on a single sheet of paper or may be data for forming an image on multiple sheets of paper. In addition, the print job can include information indicative of whether color or monochrome printing is used and information indicative of the number of copies to be printed (number of page sets), the number of sheets to be printed per copy (number of pages), and the like, as control data. Moreover, the auxiliary storage device 103 includes a nonvolatile memory, such as an electrically-rewritable program read only memory (ROM). The control programs can be stored in the nonvolatile memory.

The communication interface 104 is an interface for communicating with the user terminals that are external devices on a network NW. For example, the communication interface 104 is configured as an LAN connector. Moreover, the communication interface 104 may wirelessly communicate with other devices in accordance with standards such as Bluetooth (registered trademark) or Wi-fi (registered trademark).

The external storage medium interface 105 is a reader/writer for a removable computer-readable storage medium, such as a universal serial bus (USB) memory.

An operator of the image forming apparatus 10 inputs various instructions in the operation panel 106. The operation panel 106 sends a signal indicating an instruction input by the operator to the processor 101. The operation panel 106 includes, for example, a keyboard, a ten key, a touch panel, and the like as operation units. Moreover, the operation panel 106 displays a variety of information to the operator of the image forming apparatus 10. In other words, the operation panel 106 displays a screen showing the a variety of information on the basis of a signal from the processor 101. The operation panel 106 includes, for example, a monitor, such as a liquid-crystal display, as a display unit.

The scanner 107 optically scans a document and reads the image of the document as image data. The scanner 107 reads the document as a color image. The scanner 107 is constituted by a sensor array and the like that are formed in a main scanning direction. The scanner 107 moves the sensor array in a sub-scanning direction and reads the entire document.

The input image processing unit 108 processes the image data read by the scanner 107. Moreover, the input image processing unit 108 may process image data read from the removable computer-readable storage medium through the external storage medium interface 105. In addition, the input image processing unit 108 converts data to be printed, such as character data and image data, included in the print job stored in the auxiliary storage device 103, into image data indicating the image to be formed.

The page memory 109 stores the image data processed by the input image processing unit 108.

The output image processing unit 110 processes the image data stored in the page memory 109 so that the printer 111 can print the image data onto paper.

Under the control of the processor 101, the printer 111 prints the image data processed by the output image processing unit 110 onto paper. The printer 111 prints the image data onto paper by an electrophotographic method, for example.

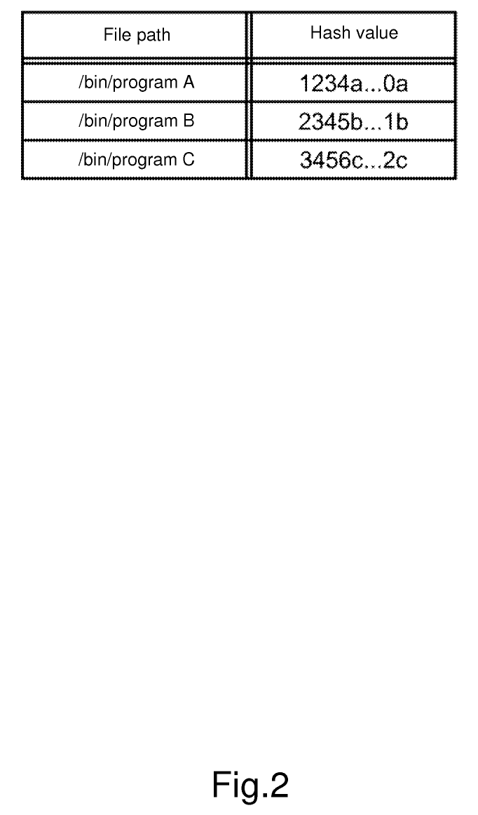

FIG. 2 is a schematic diagram showing an example of the registration contents of the white list file stored in the white list file storage unit 1032. For example, the white list file can be implemented as a text file in a CSV format where information about each of the application programs stored in the program storage unit 1031 is a single record. Each record includes file path information of the program storage unit 1031, which is a storage destination of a program file of the corresponding application program, and a hash value calculated from the program file. For example, data on the hash value may be a value calculated by a general hash function like MD5 using the program file as an input. The example of FIG. 2 shows a case where three application programs (application programs A, application program B, and application program C) are stored in the program storage unit 1031.

It should be noted that as will be described later, the white list file to be stored in the white list file storage unit 1032 is to be updated when an authorized person authorized to install the application programs, such as an administrator or serviceman, updates the application programs stored in the program storage unit 1031.

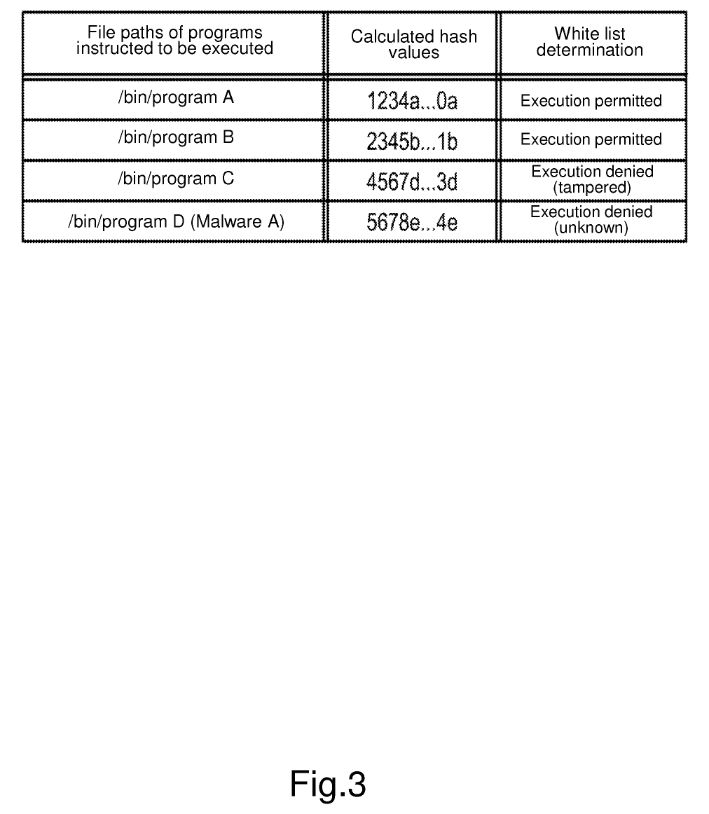

FIG. 3 is a schematic diagram showing an example of a determination result as to whether or not the execution is permitted based on the white list at a program execution start time in the processor 101. When the processor 101 attempts to execute an application program of the program file stored in the program storage unit 1031, the processor 101 determines whether or not the execution of the application program is permitted on the basis of the registration contents of the white list file stored in the white list file storage unit 1032. Specifically, the processor 101 calculates a hash value of the program file of the application program which is instructed to be executed, that is, which is to be activated, and checks whether or not the hash value corresponding to the program file stored in the white list file storage unit 1032 matches the calculated hash value. In a case where both match, the execution of the application program is permitted. In a case where both do not match, the execution of the application program is denied.

It should be noted that there are two cases where the hash value calculated from the program file and the hash value of the white list do not match as follows. One is a case where tempering the program file makes the hash value calculated from the program file different from the hash value of the white list. The other one is a case where no corresponding hash values are registered in the white list because for example malware, not the authorized person, has installed the program file of the application program instructed to be executed. FIG. 3 shows the former is "Execution denied (tampered)" and the latter is shown as "Execution denied (unknown)."

Hereinafter, an operation associated with updating the white list in the image forming apparatus 10 with the above-mentioned configurations will be described.

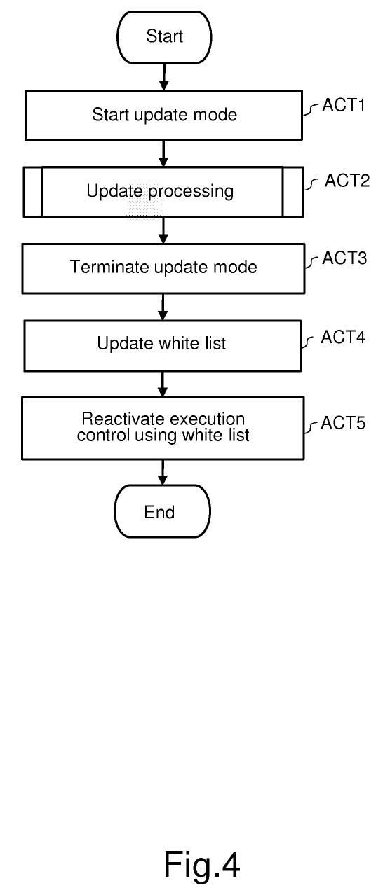

FIG. 4 is a flowchart showing an example of the white list update processing operation executed by the processor 101 of the image forming apparatus 10. The processor 101 is capable of performing the white list update processing operation by executing information processing programs according to the first embodiment that is one of the control programs stored in the auxiliary storage device 103. It should be noted that unless otherwise noted, it is assumed that the processing operation of the processor 101 shown in FIG. 4 after ACT n (n represents a natural number) transitions to ACT (n+1). Moreover, the procedure shown in FIG. 4 is an example. The procedure is not particularly limited as long as it can provide a similar result.

The authorized person authorized to install the application programs connects a computer-readable storage medium prepared in advance, such as a USB memory, to the external storage medium interface 105. The computer-readable storage medium has stored an update file and an update program that causes the processing of updating the storage contents of the auxiliary storage device 103 with the update file to be executed. The update file includes a file for overwriting and storing various update target files stored in the auxiliary storage device 103, which include the program file stored in the program storage unit 1031, and newly stored files not stored in the auxiliary storage device 103. That is, in the present specification, the term "updating" have both meanings of "overwriting" and "adding." The processor 101 starts the white list update processing operation shown in FIG. 4 when a program update request is input from the authorized person by a predetermined operation on the operation panel 106. Alternatively, when the computer-readable storage medium is connected to the external storage medium interface 105, the processor 101 may automatically check whether or not the update program has been stored in the computer-readable storage medium and start the white list update processing operation shown in FIG. 4 in response to finding of the update program. Here, the authorized person's action itself of connecting the computer- readable storage medium with the update program stored therein to the external storage medium interface 105 can be considered as the program update request.

When the white list update processing operation is started, as ACT 1, the processor 101 starts an update mode to update an update target file including an application program as an operation mode. On the update mode, the execution of the application program is prohibited. Since the execution of the application program is prohibited in this manner, it is not particularly necessary to suspend the execution control of the application program using the white list. As a matter of course, on this update mode, the execution control of the application program using the white list may also be prohibited.

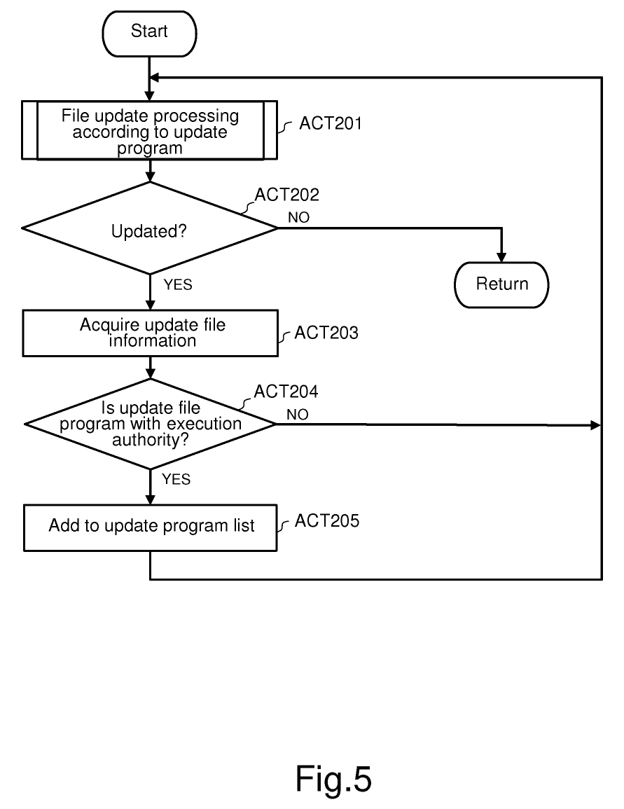

As ACT 2, the processor 101 performs an update processing operation of updating the update target file with the update file stored in the computer-readable medium. FIG. 5 is a flowchart showing an example of this update processing operation.

First of all, as ACT 201, the processor 101 performs update processing with a single update file in accordance with the update program stored in the computer-readable storage medium.

As ACT 202, the processor 101 determines whether or not the update with the update file has actually happened. In a case where no files are updated even when the update processing in ACT 201 is performed, that is, the file update processing on the auxiliary storage device 103 using all update files stored in the computer-readable storage medium is completed, the processor 101 determines NO in ACT 202, terminates the update processing operation in ACT 2 shown in this flowchart, and proceeds to the processing in ACT 3. In a case where the update with the update

file has happened, the processor 101 determines YES in ACT 202 and the processor 101 proceeds to the processing in ACT 203.

As ACT 203, the processor 101 acquires file information about the updated update file. Specifically, the processor 101 acquires a file attribute of the update file and file path information of the storage destination. The file attribute includes information about whether or not there is authority to execute the file. Files with execution authority are program files. Files with no execution authority are files other than the program files, such as setting files and data files.

As ACT 204, the processor 101 determines whether or not the update file is a program file with execution authority. In a case where the update file is not the program file with execution authority, the processor 101 determines NO in ACT 204, proceeds to the processing operation in ACT 201, and performs update processing using a next update file. In a case where the update file is the program file with execution authority, the processor 101 determines YES in ACT 204 and proceeds to the processing operation in ACT 205.

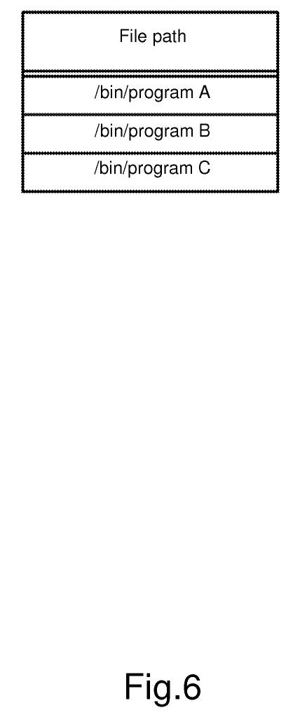

As ACT 205, the processor 101 adds a file path of the update file to the update program list generated in the temporary storage unit 1021 of the main memory 102. FIG. 6 is a schematic diagram showing an example of this update program list. The update program list is a list of file paths of update files. The file path includes a directory (e.g., "/bin") of the program storage unit 1031 of the auxiliary storage device 103 that is a storage destination of the update file and a file name (e.g., "program A") of an application file that is the update program. Then, the processor 101 proceeds to the processing operation in ACT 201 and performs update processing using a next update file.

Returning to the description of FIG. 4, as ACT 3, the processor 101 terminates the update mode and returns the operation mode to a normal mode.

As ACT 4, the processor 101 updates the white file list stored in the white list file storage unit 1032 on the basis of the update program list generated in the temporary storage unit 1021. That is, the processor 101 calculates the hash value related to each of application files shown in the update program list and registers the white file list. In this registration, regarding application programs registered in the white file list, the registered file paths and the hash values are overwritten and saved. Moreover, regarding an application program not registered in the white file list, the file path and the hash value are added and registered. Since the white list file is updated on the basis of the update program list in this manner, the update task is performed only for the actually updated application program file. Conversely, regarding the application program files not listed in the update program list, that is, not updated, the file paths and hash values registered in the white file list are maintained without hash value calculation.

As ACT 5, the processor 101 reactivates the execution control of the application program using the white list. Accordingly, the execution control of the application program using the updated white list file is performed. It should be noted that this "reactivation" is a "reset" operation of temporarily suspending and reactivating this activated execution control. If this execution control is suspended when the operation mode is shifted to the update mode in ACT 1, "reactivation" is activating the suspended execution control. Then, the processor 101 terminates the white list update processing operation shown in this flowchart.

As described above, the image forming apparatus 10 in the first embodiment includes the auxiliary storage device 103 and the processor 101. The auxiliary storage device 103 includes the program storage unit 1031 and the white list file storage unit 1032. The program storage unit 1031 stores an entity of an installed program. The white list file storage unit 1032 stores the white list that is a list of pairs of the file path information of the program and the hash value calculated from the program for determining whether or not the execution of the program is permitted. The processor 101 determines whether or not the execution of the program is permitted on the basis of the white list at the start of the execution of the program, and executes the program permitted to be executed. The image forming apparatus 10 is an example of the information processing apparatus according to the first embodiment. The auxiliary storage device 103 is an example of the storage. The pair of the file path information and the hash value is an example of the discriminative information. Then, the processor 101 of the image forming apparatus 10 enters the update mode to prohibit the execution of the program and update the program in response to the program update request from the authorized person authorized to install the program, and terminates the update mode in accordance with update end of the program. Moreover, on the update mode, the processor 101 generates a program list constituted by the file path in the storage of the program generated by the update. Then, the processor 101 rebuilds the white list on the basis of the update program list. In this manner, in accordance with the information processing apparatus according to the first embodiment, the operation mode is switched to the "update mode" before the update start of the file and is returned to the normal mode after the updating, such that the authorized person, such as the administrator or serviceman, can update the application program file without taking care of generation of the white list during the update task. Moreover, only the updated application program is added and/or rewritten to the white list, such that the update time of the white list can be reduced as compared to a case where all application programs are re-registered in the white list.

Here, the processor 101 updates the program on the update mode, generates the update program list in accordance with the update of the program, generates the update program list, and then terminates the update mode. Then, the processor 101 rebuilds the white list on the basis of the update program list and starts determination as to whether or not the execution of the program is permitted the rebuilt white list. Therefore, in accordance with the first embodiment, only the updated program can be reliably registered in the update program list because the update program list of only the actually updated program is generated on the update mode.

### Second Embodiment

Although the actual update of the program is detected and the update program list is generated in the above-mentioned first embodiment, it is also possible to generate the update program list before the actual update of the program. Hereinafter, it will be described as a second embodiment. It should be noted that configurations and operations similar to those of the first embodiment will be denoted by reference signs similar to those of the first embodiment and descriptions thereof will be omitted.

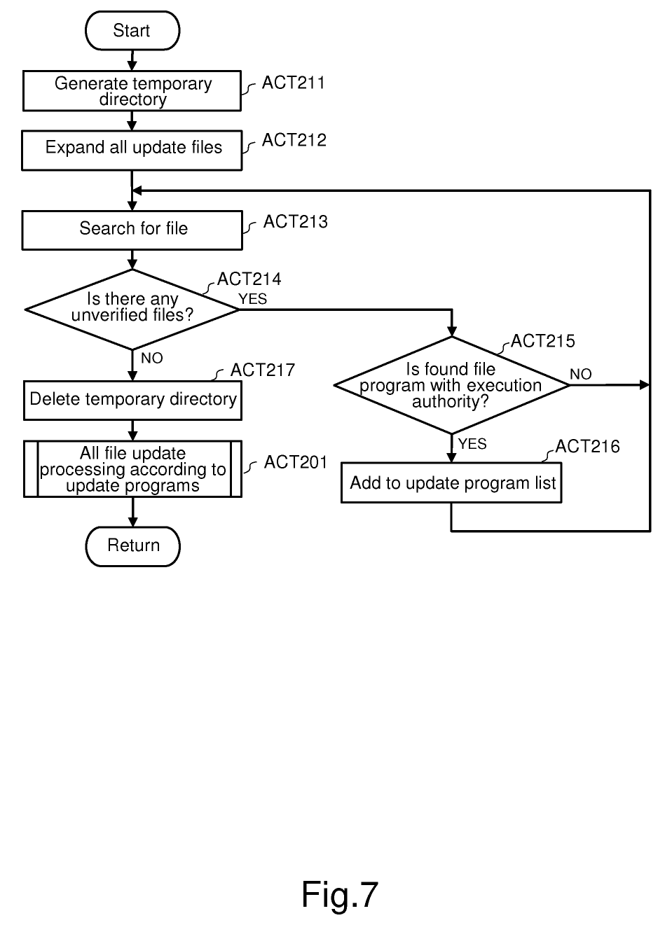

Configurations and operations of the image forming apparatus 10 that is an information processing apparatus according to the second embodiment are similar to those of the first embodiment except that the update processing operation performed in ACT 2 of the white list update processing operation is different from that of the first embodiment. Hereinafter, this update processing operation will be described with reference to a flowchart showing an example of the update processing operation in the white list update processing operation performed by the processor 101 of the image forming apparatus 10 according to the second embodiment in FIG. 7.

As ACT 211, the processor 101 generates a temporary directory (e.g., "/tmp") in the auxiliary storage device 103.

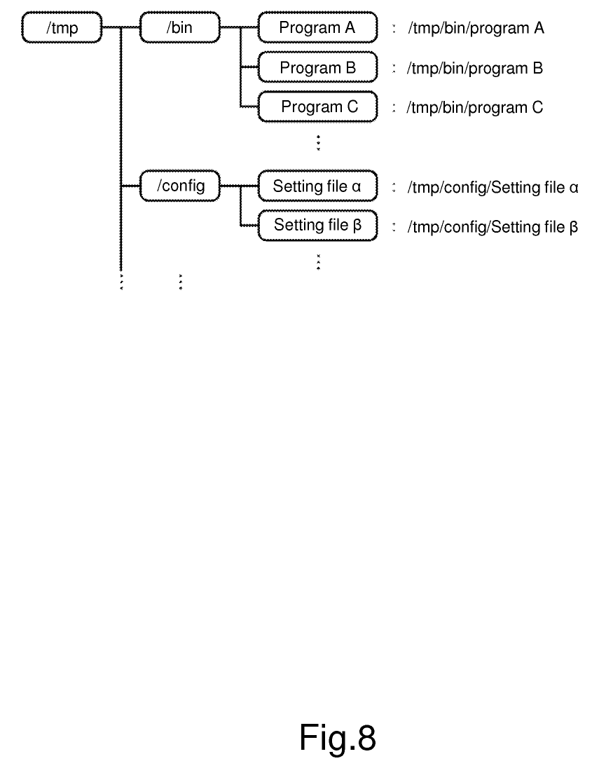

As ACT 212, the processor 101 expands to the temporary directory all update files to be updated, which have been stored in the computer-readable storage medium via the external storage medium interface 105. At this time, the directory structure inside the computer-readable storage medium is held in the temporary directory. FIG. 8 is a schematic diagram showing an example of the update files expanded to the temporary directory. As shown in FIG. 8, program files with execution authority are expanded to a program directory (e.g., "/bin") under the temporary directory. Also, setting files are expanded to a setting directory (e.g., "/config") under the temporary directory.

As ACT 213, the processor 101 searches the temporary directory as a search target for the update file.

As ACT 214, the processor 101 determines whether or not there are any unverified files in the temporary directory. Here, the unverified file refers to a file for which a determination in ACT 215 to be described later has not been performed. In a case where there are no unverified files in the temporary directory, the processor 101 determines NO in ACT 214 and proceeds to the processing in ACT 217. In a case where there are any unverified files in the temporary directory, the processor 101 determines YES in ACT 214 and proceeds to the processing in ACT 215.

As ACT 215, the processor 101 determines whether or not a file found as a result of the file search in ACT 213 is the program file with execution authority. In a case where the found file is not the program file, the processor 101 determines NO in ACT 215, proceeds to the processing in ACT 213, and searches for a next file. In a case where the found file is the program file, the processor 101 determines YES in ACT 215 and proceeds to the processing in ACT 216.

As ACT 216, the processor 101 adds the file path of the found program file to the update program list generated in the temporary storage unit 1021 of the main memory 102. This update program list is as described above with respect to the first embodiment. Therefore, in the present embodiment, the processor 101 adapts the file path to be added to the update program list to be a file path stored in the program storage unit 1031 by a normal update operation. Specifically, the processor 101 registers, in the update program list, the path below "/bin" excluding the path "/tmp" in the temporary directory. Then, the processor 101 proceeds to the processing operation in ACT 213 and searches for a next file.

As described above, in the image forming apparatus 10 that is the information processing apparatus according to the second embodiment, the processor 101 expands the programs to be updated in the temporary directory generated in the auxiliary storage device 103 on the update mode. The processor 101 generates the update program list in accordance with the programs expanded to the temporary directory. The processor 101 deletes the programs expanded to the temporary directory after the generation of the update program list. The processor 101 actually updates the programs. The processor 101 terminates the update mode after update end of the programs. The processor 101 rebuilds a white list on the basis of the update program list. The processor 101 starts determination as to whether or not the execution of the program is permitted based on the rebuilt white list. In this manner, the second embodiment can provide effects similar to those of the first embodiment by temporarily expanding all the update programs to the temporary directory, enumerating the file path information of the programs included in the paths below the temporary directory, and using this as the update program list.

Here, the processor writes the paths of the program storage unit 1031 in which the programs to be updated are actually installed in the update program list during the generation of the update program list. Therefore, the update program list similar to that of the first embodiment can be generated.

### Other Embodiments

Although the embodiments of the information processing system and the information processing apparatus have been described above, those embodiments are not limited thereto.

Although the image forming apparatus 10 that is the MFP has been described as an example of the information processing apparatus, the information processing apparatus may be an office apparatus, such as a Point of Sale (POS) terminal.

Moreover, although the update file is acquired from the removable computer-readable storage medium, such as the USB memory, the update file may be acquired from an external device, such as a file server on the network NW via the communication interface 104.

Moreover, the above-mentioned flow of information processing performed by the processor 101 described above with reference to the flowchart is an example, and is not intended to limit the order. For example, the update processing of the white file list based on the update program list in ACT 4 may be performed in the update processing in ACT 2 on the update mode. Moreover, the processing order may be changed or a plurality of processes may be performed in parallel as long as there is no conflict with the preceding or subsequent process.

It should be noted that the above-mentioned embodiments, the information processing programs that are the control programs are prestored in the auxiliary storage device 103 of the image forming apparatus 10. In this regard, a control program delivered separately from the image forming apparatus 10 may be written in a writable storage device provided in the image forming apparatus 10 in accordance with an operation made by the administrator or the like. These control programs and the like can be delivered, stored in the removable computer-readable storage medium or by communication via the network. The computer-readable storage medium can take any form as long as it can store the programs and the apparatus can read them like a CD-ROM, a memory card, or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus that determines, when the information processing apparatus determines attempts to execute a program running on the information processing apparatus, whether or not the execution of the program is permitted, comprising:
a storage device configured to save a white list that is a list of an entity of an installed program and discriminative information for determining whether or not the execution of the program is permitted; and
a processor configured to
enter an update mode to prohibit the execution of the program and update the program in response to a program update request from an authorized person authorized to install the program and terminate the update mode in accordance with update end of the program,
generate, on the update mode, an update program list constituted by a file path in the storage device of the program generated by the update, and
rebuild the white list on the basis of the update program list.

2. The information processing apparatus according to claim 1, wherein
the processor on the update mode generates an update program list that lists an actually updated program.

3. The information processing apparatus according to claim 2, wherein
the processor
on the update mode,
updates the program,
generates the update program list in accordance with the update of the program, and
terminates the update mode after generating the update program list,
rebuilds the white list on the basis of the update program list, and
starts determination as to whether or not the execution of the program is permitted, the determination being based on the rebuilt white list.

4. The information processing apparatus according to claim 1, wherein
the processor
on the update mode,
expands the program to be updated to a temporary directory of the storage device,
generates the update program list in accordance with the program expanded to the temporary directory,
deletes the program expanded to the temporary directory after generating the update program list,
updates the program, and
terminates the update mode after update end of the program,
rebuilds the white list on the basis of the update program list, and
starts determination as to whether or not the execution of the program is permitted, the determination being based on the rebuilt white list.

5. The information processing apparatus according to claim 4, wherein
the processor writes a path of the storage device in which the program to be updated is actually installed in the update program list during generation of the update program list.

6. The information processing apparatus according to claim 1, further comprising
an external storage medium interface, wherein
the storage device includes various update target files including the program, and
the processor acquires update file information in which the update target file is updated in a case where an external storage medium storing an update file for updating the various update target files is connected as the update request.

7. The information processing apparatus according to claim 6, wherein
the update file information contains a file attribute and file path information of the update file, the file attribute including information about whether or not there is authority to execute the update file, and
the processor determines whether or not an update target file updated by the update file is the program on the basis of the file attribute contained in the update file information.

8. The information processing apparatus according to claim 7, wherein
the processor adds the file path information to the update program list in a case where the update target file updated by the update file is the program.

9. The information processing apparatus according to claim 1, wherein
the discriminative information is a pair of file path information and a hash value, and
the white list is a list of pairs each being the pair of the file path information and the hash value related to each installed program.

10. An information processing method for an information processing apparatus that determines, when the information processing apparatus determines attempts to execute a program running on the information processing apparatus, whether or not the execution of the program is permitted, comprising:
saving a white list that is a list of an entity of an installed program and discriminative information for determining whether or not the execution of the program is permitted;
entering an update mode to prohibit the execution of the program and update the program in response to a program update request from an authorized person authorized to install the program and terminating the update mode in accordance with update end of the program;
generating, on the update mode, an update program list constituted by a file path in the storage device of the program generated by the update; and
rebuilding the white list on the basis of the update program list.
